(19) United States
(12) Patent Application Publication
(10) Pub. No.: US 2015/0324352 A1
(43) Pub. Date: Nov. 12, 2015

(54) SYSTEMS AND METHODS FOR DYNAMICALLY COLLECTING AND EVALUATING POTENTIAL IMPRECISE CHARACTERISTICS FOR CREATING PRECISE CHARACTERISTICS

(71) Applicant: Intelligent Digital Avatars, Inc., Mequon, WI (US)

(72) Inventors: Thomas W. Meyer, Berkeley, CA (US); Mark Stephen Meadows, Emeryville, CA (US); Navroz Jehangir Daroga, Mequon, WI (US)

(21) Appl. No.: 14/710,340

(22) Filed: May 12, 2015

Related U.S. Application Data
(60) Provisional application No. 61/992,186, filed on May 12, 2014.

(51) Int. Cl. G06F 17/28; G10L 15/25; G06F 3/01; G06T 7/20

(52) U.S. Cl. CPC G06F 17/28; G06T 7/20; G10L 15/25; G06F 3/015

(57) ABSTRACT

Aspects of the present disclosure are directed to systems and methods for evaluating an individual's affect or emotional state by extracting emotional meaning from audio, visual and/or textual input into a handset, mobile communication device or other peripheral device. The audio, visual and/or textual input may be collected, gathered or obtained using one or more data modules which may include, but are not limited to, a microphone, a camera, an accelerometer and a peripheral device. The data modules collect one or more sets of potential imprecise characteristics which may then be analyzed and/or evaluated. When analyzing and/or evaluating the imprecise characteristics, the imprecise characteristics may be assigned one or more weighted descriptive values and a weighted time value. The weighted descriptive values and the weighted time value are then compiled or fused to create one or more precise characteristics which may define the emotional state of an individual.

### CLAIM OF PRIORITY UNDER 35 U.S.C. §119

The present Application for Patent claims priority to U.S. Provisional Application No. 61/992,186 entitled “SYSTEMS AND METHODS FOR MEASURING MOOD VIA SEMANTIC AND BIOMETRIC RELATIONAL INPUT VECTORS ”, filed May 12, 2014, and hereby expressly incorporated by reference herein.

### FIELD

The present application relates to systems and methods for collecting and evaluating one or more sets of potential imprecise characteristics for creating one or more precise characteristics.

### BACKGROUND

Computational systems, be they avatars, robots, or other connected systems, are often deployed with the intent to carry out dialogue and engage in conversation with users, also known as human conversants, or the computational system may be deployed with the intent to carry out dialogue with other computational systems. This interface to information that uses natural language, in English and other languages, represents a broad range of applications that have demonstrated significant growth in application, use, and demand. Virtual nurses, home maintenance systems, talking vehicles, or systems we wear and can talk with all require a trust relationship and, in most cases, carry elements of emotional interaction.

Interaction with computational systems has been limited in sophistication, in part, due to the inability of computer-controlled systems to both recognize and convey the mood, intent, and sentiment of a member of the conversation (sometimes referred to as the affect) which are important to better understand what is meant. Some of this is conveyed through language, some through gesture. Non-textual forms of communication are currently missing in natural language processing methods, and specifically the processing of textual natural language. This leaves a large gap for misunderstanding as many of these non-textual forms of communication that people use when speaking to one another, commonly called “body language,” or “tone of voice” or “expression” convey a measurably large set of information. In some cases, such as sign language, all the data of the dialogue may be contained in non-textual forms of communication.

Elements of communication that are both textual (Semantic) and non-textual (Biometric) may be measured by computer-controlled software. First, in terms of textual information, the quantitative analysis of semantic data, natural language and dialogue, such as syntactic, affective, and contextual elements, yields a great deal of data and information about intent, personality, era, and the author. This kind of analysis may be performed; however texts often contain few sentences that contain sentiment, mood, and affect. This makes it difficult to make an informed evaluation of the author's, or speaker's, intent or emotional state based on the content. Second, in terms of biometric information, or non-textual information, somatics, polygraphs, and other methods of collecting biometric information such as, heart rate, facial expression, tone of voice, posture, gesture, and so on have been in use for some time. These biometric sets of information have also traditionally been measured by computer-controlled software and as with textual analysis; there is a degree of unreliability due to differences between people's methods of communication, reaction, and other factors.

Computationally-derived semantic and biometric data have traditionally each lacked reliable data and have not been combined with the end goal of measuring conversant sentiment and mood. Using only one of these two methods leads to unreliable results, poor data that can create uncertainty in business decisions, interaction, the ability to measure intent, and other aspects that cost great deals of time and money.

In view of the above, what are needed are systems and methods for building a reliable sentiment analysis module by collecting and evaluating one or more sets of potential imprecise characteristics for creating one or more precise characteristics.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts or examples of one or more implementations in a simplified form as a prelude to the more detailed description that is presented later.

Various aspects of the disclosure provide for a computer implemented method of dynamically collecting and evaluating one or more sets of potential imprecise characteristics for creating one or more precise characteristics, comprising executing on a processor the steps of collecting a first plurality of potential imprecise characteristics from a first data module in communication with the processor; assigning each potential imprecise characteristic in the first plurality of potential imprecise characteristics at least one first weighted descriptive value and a first weighted time value, and storing the first plurality of potential imprecise characteristics, the at least one first weighted descriptive value and the first weighted time value in a memory module; collecting a second plurality of potential imprecise characteristics from a second data module in communication with the processor; assigning each potential imprecise characteristic in the first plurality of potential imprecise characteristics at least one second weighted descriptive value and a second weighted time value, and storing the second plurality of potential imprecise characteristics, the at least one second weighted descriptive value and the second weighted time value in the memory module; and dynamically computing the one or more precise characteristics by combining the descriptive values and the weighted time values.

According to one feature, the method may further comprise executing on the processor the steps of collecting a third plurality of potential imprecise characteristics from a third data module in communication with the processor; and assigning each of the third plurality of potential imprecise characteristics in the third plurality of potential imprecise characteristics at least one third weighted descriptive value and a third weighted time value, and storing the third plurality of potential imprecise characteristics, the at least one third weighted descriptive value and the third weighted time value in the memory module.

According to another feature, the first data module is a camera-based biometric data module that includes a position module for analyzing images and/or video captured from the camera-based biometric data module to determine the each potential imprecise characteristic in the first plurality of potential imprecise characteristics. Each of the imprecise characteristic in the first plurality of potential imprecise characteristics may include at least one of head related data and body related data based head and body positions of an individual in the images and/or video.

According to yet another feature, the second data module is a peripheral data module that includes a biotelemetrics module for analyzing data from the peripheral data module to determine the each potential imprecise characteristic in the second plurality of potential imprecise characteristics. Each of the potential imprecise characteristics in the the second plurality of potential imprecise characteristics includes at least one of heart rate, breathing rate and body temperature of an individual.

According to yet another feature, the at least one first weighted descriptive value is assigned by comparing the each potential imprecise characteristic in the first plurality of potential imprecise characteristics to pre-determined characteristics located in a characteristic database. The at least one second weighted descriptive value is assigned by comparing the each potential imprecise characteristic in the second plurality of potential imprecise characteristics to the pre-determined characteristics located in a characteristic database.

According to yet another feature, the characteristic database is dynamically built from the collected first and second plurality of potential imprecise characteristics.

According to yet another feature, the at least one first weighted time value identifies a time in which the each potential imprecise characteristic in the first plurality of potential imprecise characteristics is collected. The at least one second weighted time value identifies a time in which the each potential imprecise characteristic in the second plurality of potential imprecise characteristics is collected.

According to yet another feature, the method may further comprise executing on the processor the step of ranking the at least one first weighted descriptive value, the at least one second weighted descriptive value, the first time weighted value and the second time weighted value.

According to yet another feature, the first and second plurality of potential imprecise characteristics are collected on a handset and transmitted to a server for analysis.

According to yet another feature, the at least one first weighted descriptive value and the at least one second weighted descriptive value is assigned on the handset prior to transmission to the server.

According to yet another feature, the at least one first weighted descriptive value and the at least one second weighted descriptive value is assigned on the server.

According to another aspect, a mobile device for dynamically collecting and evaluating one or more sets of potential imprecise characteristics for creating one or more precise characteristics is provided. The devices includes a processing circuit; a communications interface communicatively coupled to the processing circuit for transmitting and receiving information; and a memory module communicatively coupled to the processing circuit for storing information. The processing circuit is configured to collect a first plurality of potential imprecise characteristics from a first data module in communication with the processor; assign each potential imprecise characteristic in the first plurality of potential imprecise characteristics at least one first weighted descriptive value and a first weighted time value in a analysis module within the processing circuit, and storing the first plurality of potential imprecise characteristics, the at least one first weighted descriptive value and the first weighted time value in the memory module; collect a second plurality of potential imprecise characteristics from a second data module in communication with the processor; assign each potential imprecise characteristic in the first plurality of potential imprecise characteristics at least one second weighted descriptive value and a second weighted time value in the analysis module within the processing circuit, and storing the second plurality of potential imprecise characteristics, the at least one second weighted descriptive value and the second weighted time value in the memory module; and dynamically computing the one or more precise characteristics by combining the descriptive values and the weighted time values in a fusion module within the processing circuit.

According to one feature, the processing circuit of the mobile device may be further configured to collect a third plurality of potential imprecise characteristics from a third data module in communication with the processor; and assign each of the third plurality of potential imprecise characteristics in the third plurality of potential imprecise characteristics at least one third weighted descriptive value and a third weighted time value, and storing the third plurality of potential imprecise characteristics, the at least one third weighted descriptive value and the third weighted time value in the memory module.

According to another feature, the at least one first weighted time value identifies a time in which the each potential imprecise characteristic in the first plurality of potential imprecise characteristics is collected; and wherein the at least one second weighted time value identifies a time in which the each potential imprecise characteristic in the second plurality of potential imprecise characteristics is collected.

According to yet another feature, the at least one first weighted descriptive value is assigned by comparing the each potential imprecise characteristic in the first plurality of potential imprecise characteristics to pre-determined characteristics located in a characteristic database. The at least one second weighted descriptive value is assigned by comparing the each potential imprecise characteristic in the second plurality of potential imprecise characteristics to the pre-determined characteristics located in a characteristic database. The characteristic database is dynamically built from the collected first and second plurality of potential imprecise characteristics.

According to yet another feature, the first data module is different than the second data module. The first data module may be a camera and the second data module may be an accelerometer.

### BRIEF DESCRIPTION OF THE DRAWINGS

FIG. 1 illustrates an example of a networked computing platform utilized in accordance with an exemplary embodiment.

FIG. 2 illustrates a flow chart illustrating a method of assessing the semantic mood of an individual by obtaining or collecting one or more potential imprecise characteristics, in accordance with an aspect of the present disclosure.

FIGS. 3A and 3B illustrate a flow chart illustrating of a method of assessing the biometric mood in the form one or more potential imprecise characteristics of an individual, in accordance with an aspect of the present disclosure.

FIG. 4 illustrates a biometric mood scale for determining an emotional value in the form of one or more potential imprecise characteristics that is associated with sentiment of an emotion, affect or other representations of moods of an individual based on facial expressions, according to an aspect of the present disclosure.

FIG. 5 illustrates mood scales for determining an emotional value in the form of one or more potential imprecise characteristics that is associated with sentiment of an emotion, affect or other representations of moods of an individual based on facial expressions and parsed conversant input, according to an aspect of the present disclosure.

FIG. 6 illustrates an example of determining the biometric mood of an individual, according to an aspect of the present disclosure, according to an aspect of the present disclosure.

FIG. 7 illustrates an example of determining the biometric mood of an individual, according to an aspect of the present disclosure, according to an aspect of the present disclosure.

FIG. 8 illustrates an example of determining the biometric mood of an individual, according to an aspect of the present disclosure, according to an aspect of the present disclosure.

FIG. 9 illustrates a graphical representation of a report on the analysis of semantic data and biometric data (or potential imprecise characteristics) collected, according to an aspect of the disclosure.

FIG. 10 illustrates a flow chart illustrating a method of a handset collecting and evaluating media streams, such as audio, according to an aspect of the present disclosure

FIG. 11 is a diagram illustrating an example of a hardware implementation for a system configured to measure semantic and biometric affect, emotion, intention and sentiment (potential imprecise and precise characteristics) via relational input vectors or other means using national language processing, according to an aspect of the present disclosure.

FIGS. 12A, 12B and 12C illustrate a method for measuring semantic and biometric affect, emotion, intention, mood and sentiment via relational input vectors using national language processing, according to one example.

FIG. 13 illustrates a method of dynamically collecting and evaluating one or more sets of potential imprecise characteristics for creating one or more precise characteristics, according to an aspect of the present disclosure.

### DETAILED DESCRIPTION OF THE INVENTION

The following detailed description is of the best currently contemplated modes of carrying out the present disclosure. The description is not to be taken in a limiting sense, but is made merely for the purpose of illustrating the general principles of the present disclosure.

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may be shown in detail in order not to obscure the embodiments.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. The word “exemplary” is used herein to mean “serving as an example, instance, or illustration.” Any implementation or embodiment described herein as “exemplary” is not necessarily to be construed as preferred or advantageous over other embodiments or implementations. Likewise, the term “embodiments” does not require that all embodiments include the discussed feature, advantage or mode of operation.

The term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another, even if they do not directly physically touch each other.

In the following description, certain terminology is used to describe certain features of one or more embodiments. The terms “mobile device” and mobile communication device” may refer to any type of handset or wireless communication device which may transfer information over a network. The mobile device may be any cellular mobile terminal, personal communication system (PCS) device, personal navigation device, laptop, personal digital assistant, or any other suitable capable of receiving and processing network signals.

The term “characteristic” may refer to a user's (or individual's) emotion, including a user's (or individual's) interaction with a device-based avatar, physical attributes of the user (including, but not limited to, age, height, physical disabilities, complexion, build and clothing) background noise and background environment. The terms “user”, “consumer”, “individual” and “conversant” may be used interchangeably. The term “complexion” may refer to the color or blemishes on the skin of the user. For example, the skin color of the user may be described as, including but not limited to, dark, light, fair, olive, pale or tan while the blemishes on the skin of the user may be pimples, freckles, spots and scars. The term “build” may refer to the physical makeup of the user. For example, the physical makeup of a person may be described as, including but not limited to, plump, stocky, overweight, fat, slim, trim, skinny, buff or well built.

The term “potential imprecise characteristics” may refer to characteristics, such as emotions, that may or may not accurately describe the affect an individual. The term “precise characteristics” may refer to characteristics, such as emotions, that accurately describe the affect of an individual.

The term “data module” may refer to any type of device that can be used to collect imprecise characteristics, including but not limited to, a microphone, a camera, an accelerometer and a peripheral device.

Input vectors may include, but are not limited to (1) Measurement of affect and sentiment based on natural language; (2) Measurement of affect and sentiment based on natural gesture; (3) Measurement of affect and sentiment based on vocal prosody; (4) Use of “Small Data” to refine user interaction; (5) Creation of sympathetic feedback loops with user based on natural language; (6) use of “Big Data” to provide broader insights towards customer behavior, intention, and patterns of behavior; and (7) Use of social media. The first three input vectors may be overlapped to build a single real-time set of affect and sentiment. These input vectors may be integrated into a system that references and compares the conversant measurements, as described below.

The term “Small Data” may refer to data about an individual and measures their ideas, preferences, emotions, and specific proclivities.

### Overview

Aspects of the present disclosure are directed to systems and methods for evaluating an individual's affect or emotional state by extracting emotional meaning from audio, visual and/or textual input into a handset, mobile communication device or other peripheral device. The audio, visual and/or textual input may be collected, gathered or obtained using one or more data modules which may include, but are not limited to, a microphone, a camera, an accelerometer and a peripheral device. The data modules collect one or more sets of potential imprecise characteristics which may then be analyzed and/or evaluated. When analyzing and/or evaluating the potential imprecise characteristics, the potential imprecise characteristics may be assigned one or more weighted descriptive values and a weighted time value. The weighted descriptive values and the weighted time value are then compiled or fused to create one or more precise characteristics which may define the emotional state of an individual. According to one feature, the weighted descriptive values may be ranked in order of priority. That is, one weighted descriptive value may more accurately depict the emotions of the individual. The ranking may be based on a pre-defined set of rules located on the handset and/or a server. For example, the characteristic of anger may be more indicative of the emotion of a user than a characteristic relating to the background environment in which the individual is located. As such, the characteristic of anger may outweigh characteristics relating to the background environment.

### Networked Computing Platform

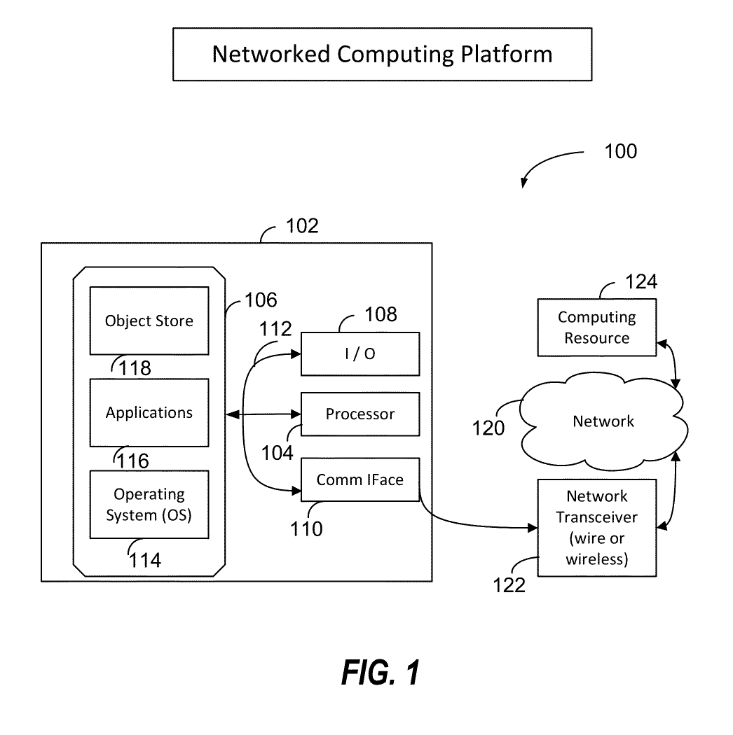

FIG. 1 illustrates an example of a networked computing platform utilized in accordance with an exemplary embodiment. The networked computing platform 100 may be a general mobile computing environment that includes a mobile computing device (or handset) and a medium, readable by the mobile computing device and comprising executable instructions that are executable by the mobile computing device. As shown, the networked computing platform 100 may include, for example, a mobile computing device 102. The mobile computing device 102 may include a processing circuit 104 (e.g., processor, processing module, etc.), memory 106, input/output (I/O) components 108, and a communication interface 110 for communicating with remote computers, such as services, or other mobile devices. In one embodiment, the afore-mentioned components are coupled for communication with one another over a suitable bus 112.

The memory (or memory module) 106 may be implemented as non-volatile electronic memory such as random access memory (RAM) with a battery back-up module (not shown) such that information stored in memory 106 is not lost when the general power to mobile device 102 is shut down. A portion of memory 106 may be allocated as addressable memory for program execution, while another portion of memory 106 may be used for storage. The memory 106 may include an operating system 114, application programs 116 as well as an object store 118. During operation, the operating system 114 is illustratively executed by the processing circuit 104 from the memory 106. The operating system 114 may be designed for any device, including but not limited to mobile devices, having a microphone or camera, and implements database features that can be utilized by the application programs 116 through a set of exposed application programming interfaces and methods. The objects in the object store 118 may be maintained by the application programs 116 and the operating system 114, at least partially in response to calls to the exposed application programming interfaces and methods.

The communication interface 110 represents numerous devices and technologies that allow the mobile device 102 to send and receive information. The devices may include wired and wireless modems, satellite receivers and broadcast tuners, for example. The mobile device 102 can also be directly connected to a computer or server to exchange data therewith. In such cases, the communication interface 110 can be an infrared transceiver or a serial or parallel communication connection, all of which are capable of transmitting streaming information.

The input/output components 108 may include a variety of input devices including, but not limited to, a touch-sensitive screen, buttons, rollers, cameras and a microphone as well as a variety of output devices including an audio generator, a vibrating device, and a display. Additionally, other input/output devices may be attached to or found with mobile device 102.

The networked computing platform 100 may also include a network 120. The mobile computing device 102 is illustratively in wireless communication with the network 120—which may for example be the Internet, or some scale of area network—by sending and receiving electromagnetic signals of a suitable protocol between the communication interface 110 and a network transceiver 122. The network transceiver 122 in turn provides access via the network 120 to a wide array of additional computing resources 124. The mobile computing device (or handset) 102 is enabled to make use of executable instructions stored on the media of the memory (or memory module) 106, such as executable instructions that enable computing device (or handset) 102 to perform steps such as combining language representations associated with states of a virtual world with language representations associated with the knowledgebase of a computer-controlled system, in response to an input from a user, to dynamically generate dialog elements from the combined language representations.

### Semantic Mood Assessment

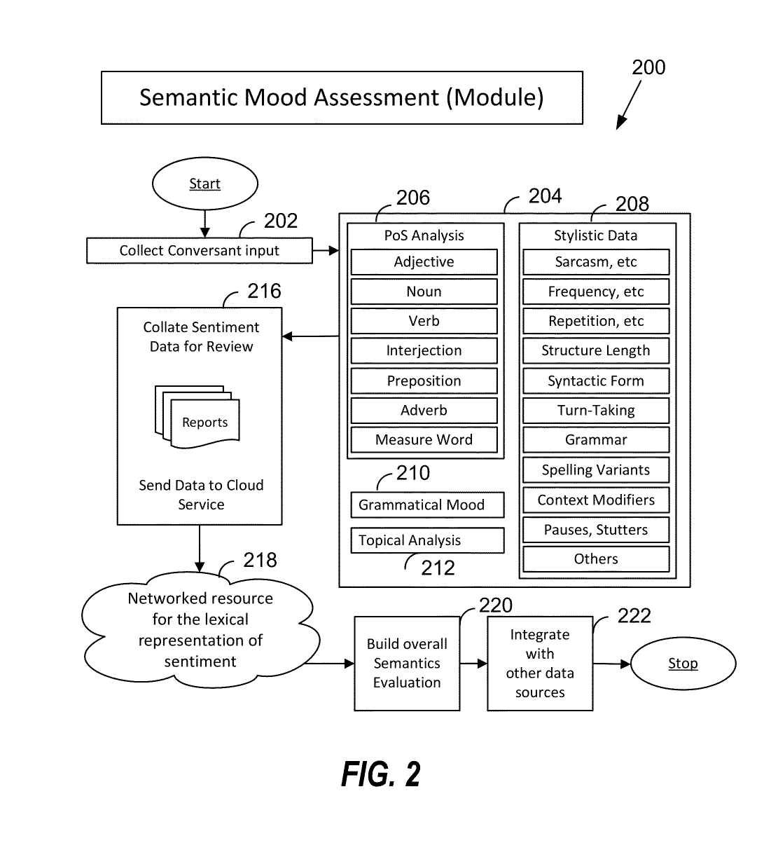

FIG. 2 illustrates a flow chart illustrating a method of assessing the semantic mood of an individual by obtaining or collecting one or more potential imprecise characteristics, in accordance with an aspect of the present disclosure. First, conversant input from a user (or individual) may be collected 202. The conversant input may be in the form of audio, visual or textual data generated via text, gesture, and/or spoken language provided by users.

According to one example, the conversant input may be spoken by an individual speaking into a microphone. The spoken conversant input may be recorded and saved. The saved recording may be sent to a voice-to-text module which transmits a transcript of the recording. Alternatively, the input may be scanned into a terminal or may be a graphic user interface (GUI).

Next, a semantic module may segment and parse the conversant input for semantic analysis 204 to obtain one or more potential imprecise characteristics. That is, the transcript of the conversant input may then be passed to a natural language processing module which parses the language and identifies the intent (or potential imprecise characteristics) of the text. The semantic analysis may include Part-of-Speech (PoS) Analysis 206, stylistic data analysis 208, grammatical mood analysis 210 and topical analysis 212.

In PoS Analysis 206, the parsed conversant input is analyzed to determine the part or type of speech in which it corresponds to and a PoS analysis report is generated. For example, the parsed conversant input may be an adjective, noun, verb, interjections, preposition, adverb or a measured word. In stylistic data analysis 208, the parsed conversant input is analyzed to determine pragmatic issues, such as slang, sarcasm, frequency, repetition, structure length, syntactic form, turn-taking, grammar, spelling variants, context modifiers, pauses, stutters, grouping of proper nouns, estimation of affect, etc. A stylistic analysis data report may be generated from the analysis. In grammatical mood analysis 210, the grammatical mood of the parsed conversant input may be determined (i.e. potential imprecise characteristics). Grammatical moods can include, but are not limited to, interrogative, declarative, imperative, emphatic and conditional. A grammatical mood report is generated from the analysis. In topical analysis 212, a topic of conversation is evaluated to build context and relational understanding so that, for example, individual components, such as words may be better identified (e.g., the word “star” may mean a heavenly body or a celebrity, and the topic analysis helps to determine this). A topical analysis report is generated from the analysis.

Once the parsed conversant input has been analyzed, all the reports relating to sentiment data of the conversant input are collated 216. As described above, these reports may include, but are not limited to a PoS report, a stylistic data report, grammatical mood report and topical analysis report. The collated reports may be stored in the Cloud or any other storage location.

Next, from the generated reports, the vocabulary or lexical representation of the sentiment of the conversant input may be evaluated 218. The lexical representation of the sentiment of the conversant input may be a network object that evaluates all the words identified (i.e. from the segmentation and parsing) from the conversant input, and references those words to a likely emotional value that is then associated with sentiment, affect, and other representations of mood. Emotional values, also known as weighted descriptive values, are assigned for creating a best guess or estimate as to the individual's (or conversant's) true emotional state. According to one example, the potential characteristic or emotion may be “anger” and a first weighted descriptive value may be assigned to identify the strength of the emotion (i.e. the level of perceived anger of the individual) and a second weighted descriptive value may be assigned to identify the confidence that the emotion is “anger”. The first weighted descriptive value may be assigned a number from 0-3 (or any other numerical range) and the second weighted descriptive value may be assigned a number from 0-5 (or any other numerical range). These weighted descriptive values may be stored in a database of a memory module located on a handset or a server.

According to one feature, the weighted descriptive values may be ranked in order of priority. That is, one weighted descriptive value may more accurately depict the emotions of the individual. The ranking may be based on a pre-defined set of rules located on the handset and/or a server. For example, the characteristic of anger may be more indicative of the emotion of a user than a characteristic relating to the background environment in which the individual is located. As such, the characteristic of anger may outweigh characteristics relating to the background environment.

Each potential imprecise characteristic identified from the data may also be assigned a weighted time value corresponding to a synchronization timestamp embedded in the collected data. Assigning a weighted time value may allow for time-varying streams of data, from which the potential imprecise characteristics are identified, to be accurately analyzed. That is, potential imprecise characteristics identified within a specific time frame are analyzed to determine the one or more precise characteristics. This accuracy may allow for emotional swings, which typically take several seconds to manifest, in emotion from an individual to be captured.

According to one example, for any given emotion, such as “anger”, the probability of it reflecting the individual's (or conversant's) actual emotion (i.e. strength of the emotion) may be approximated using the following formula:

P(i)=w₀*t₀(t)*c₀+ . . . wᵢ*tᵢ(t)*cᵢ+wₚ*P(i−1)

Where w is a weighting factor, t is a time-based weighting (recent measurements are more relevant than measurements made several second ago), and c is the actual output from the algorithm assigning the weighted descriptive values. The final P(i−1) element may be a hysteresis factor, where prior estimates of the emotional state may be used (i.e. fused, compiled) to determine a precise estimate or precise characteristic estimate as emotions typically take time to manifest and decay.

According to one example, for any given emotion, such as “anger”, the estimated strength of that emotion may be approximated using the following formula:

S(i)=w₀*t₀(t)*s₀+wᵢ*tᵢ(t)*sᵢ+wₛ*S(i−1)

Next, using the generated reports and the lexical representation, an overall semantics evaluation may be built or generated 220. That is, the system generates a recommendation as to the sentiment and affect of the words in the conversant input. This semantic evaluation may then compared and integrated with other data sources, specifically the biometric mood assessment data. 222.

According to one aspect, characteristics of an individual may be learned for later usage. That is, as the characteristics of an individual are gathered, analyzed and compiled, a profile of the individual's behavioral traits may be created and stored in the handset and/or on the server for later retrieval and reference. The profile may be utilized in any subsequent encounters with the individual. Additionally, the individual's profile may be continually refined or calibrated each time audio, visual and/or textual input associated with the individual is collected and evaluated. For example, if the individual does not have a tendency to smile even when providing positive information, when assigning weighted descriptive values to additional or subsequently gathered characteristics for that individual, these known behavioral traits of the individual may be taken into consideration. In other words, the system may be able to more accurately recognize emotions of that specific individual by taking into consideration the individual's known and document behavioral traits.

According to one aspect, in addition to profiles for specific individual, general profiles of individuals may be generated. As audio, visual and/or textual input of each additional individual is collected and evaluated, this information may be utilized to further develop multiple different profiles. For example, the system may store profiles based on culture, gender, race and age. These profiles may be taken into consideration when assigning weighted descriptive values to subsequent individuals. The more characteristics that are obtained and added to the profiles, the higher the probability that the collected and evaluated characteristics of an individual are going to be accurate.

### Biometric (or Somatic) Mood Assessment

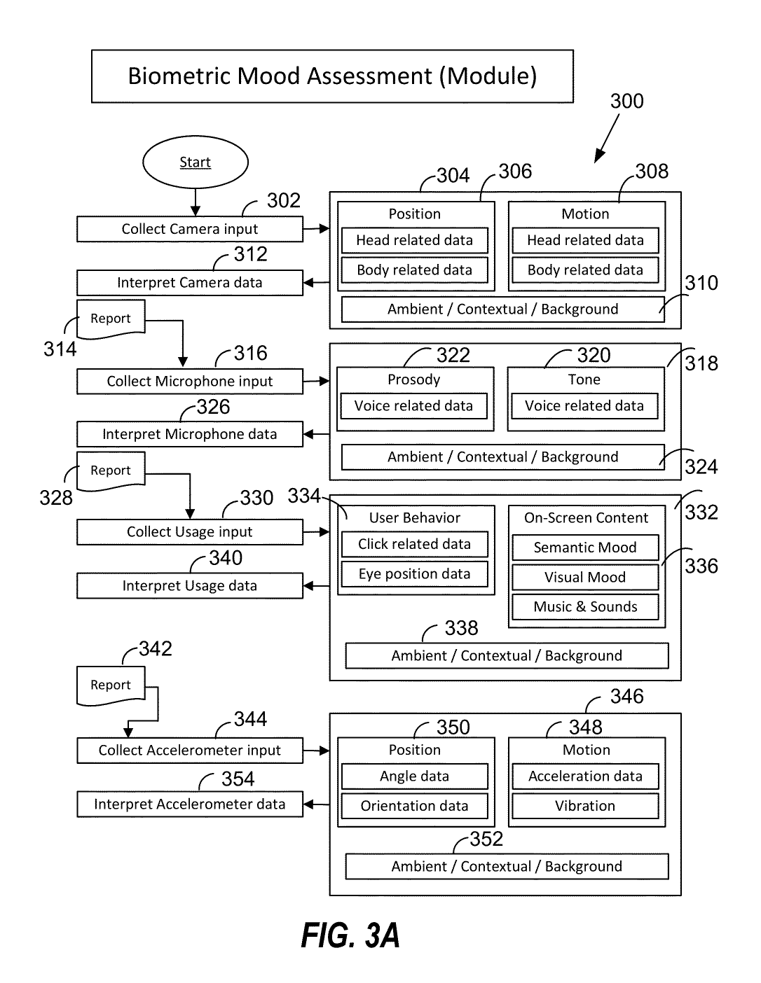

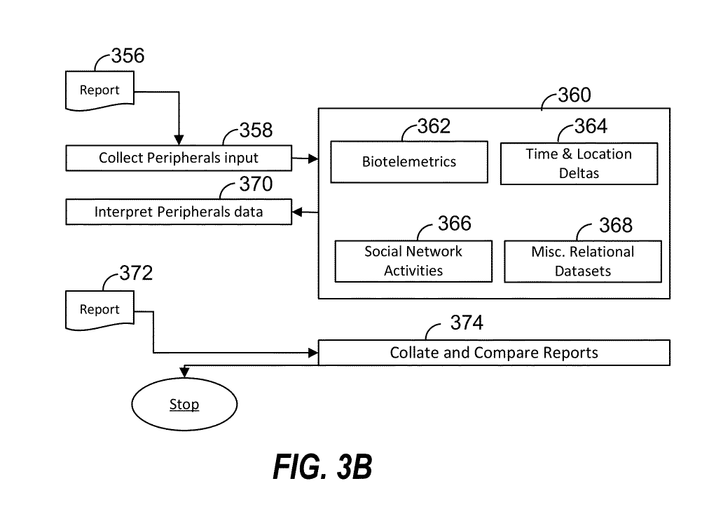

FIGS. 3A and 3B illustrate a flow chart illustrating of a method of assessing the biometric mood in the form one or more potential imprecise characteristics of an individual, in accordance with an aspect of the present disclosure. As described herein, the terms “biometric” and “somatic” may be used interchangeably.

According to one example, a camera may be utilized to collect one or more potential imprecise characteristics in the form of biometric data 302. That is, a camera may be utilized to measure or collect biometric data of an individual. The collected biometric data may be potential imprecise characteristics descriptive of the individual. The camera, or the system (or device) containing the camera, may be programmed to capture a set number of images, or a specific length of video recording, of the individual. Alternatively, the number of images, or the length of video, may be determined dynamically on the fly. That is, images and/or video of the individual may be continuously captured until a sufficient amount of biometric data to assess the body language of the individual is obtained.

A camera-based biometric data module 304 may generate biometric data from the images and/or video obtained from the camera. For example, a position module 306 within the biometric data module 304 may analyze the images and/or video to determine head related data and body related data based on the position of the head and the body of the individual in front of the camera which may then be evaluated for potential imprecise characteristics. A motion module 308 within the biometric data module 304 may analyze the images and/or video to determine head related data and body related data based on the motion of the head and the body of the individual in front of the camera. An ambient/contextual/background module 310 within the biometric data module 304 may analyze the surroundings of the individual in front of the camera to determine additional data (or potential imprecise characteristics) which may be utilized in combination with the other data to determine the biometric data of the individual in front of the camera. For example, a peaceful location as compared to a busy, stressful location will affect the analysis of the biometrics of the individual.

Next, the data obtained from the camera-based biometric data module 304 is interpreted 312 for potential imprecise characteristics and a report is generated 314. The measurements provide not only the position of the head but delta measurements determine the changes over time helping to assess the facial expression, detailed to the position of the eyes, eyebrows, mouth, scalp, ears, neck muscles, skin color, and other information associated with the visual data of the head. This means that smiling, frowning, facial expressions that indicate confusion, and data that falls out of normalized data sets that were previously gathered, such as loose skin, a rash, a burn, or other visual elements that are not normal for that individual, or group of individuals, can be identified as significant outliers and used as factors when determining potential imprecise characteristics.

This biometric data will in some cases provide a similar sentiment evaluation to the semantic data, however in some cases it will not. When it is similar an overall confidence score may be increased, i.e. weighted descriptive value as to the confidence of the characteristic. When it is not that confidence the score, or the weighted descriptive value as to the confidence of the characteristic, may be reduced. All the collected biometric data may be potential imprecise characteristics which may be combined or fused to obtain one or more precise characteristics.

According to one example, a microphone (located in a handset or other peripheral device) may be utilized to collect biometric data 316. A microphone-based biometric data module 318 may generate biometric data from the sound and/or audio obtained from the microphone. For example, a recording module 320 within the microphone-based biometric data module 318 may analyze the sounds and/or audio to determine voice related data and based on the tone of the voice of the individual near the microphone. A sound module 322 within the microphone-based biometric data module 318 may analyze the sound and/or audio to determine voice related data and sound related data based on the prosody, tone, and speed of the speech and the voice of the individual near the microphone. An ambient/contextual/background module 324 within the microphone-based biometric data module 318 may analyze the surroundings of the individual near the microphone to determine additional data (or additional potential imprecise characteristics) which may be utilized in combination with the other data to determine the biometric data of the individual near the microphone, such as ambient noise and background noise. For example, a peaceful location as compared to a busy, stressful location will affect the analysis of the biometrics of the individual. Next, the data obtained from the microphone-based biometric data module 318 may be interpreted 326 and a report is generated 328.

According to one example, the use of the application or device, such as a touch-screen, may be utilized to collect biometric data 330. A usage-based biometric data module 332 may generate biometric data from the use of the application primarily via the touch-screen of the surface of the device. This usage input may be complemented with other data (or potential imprecise characteristics) relevant to use, collected from the camera, microphone or other input methods such as peripherals (as noted below). For example, a recording module 334 within the usage-based biometric data module 332 may analyze the taps and/or touches, when coordinated with the position of the eyes, as taken from the camera, to determine usage related data and based on the speed of the taps, clicking, or gaze of the individual using the device (e.g., this usage input may be complemented with data that tracks the position of the user's eyes via the camera such that the usage of the app and where the user looks when may be tracked for biometric results). A usage module 336 within the usage-based biometric data module 332 may analyze the input behavior and/or clicking and looking to determine use related data (i.e. potential imprecise characteristics) based on the input behavior, speed, and even the strength of individual taps or touches of a user, should a screen allow such force-capacitive touch feedback. An ambient/contextual/background module 338 within the usage-based biometric data module 332 may analyze the network activity of the user or individual to determine additional data which may be utilized in combination with the other data to determine the biometric data of the individual engaged in action with the network. For example, data such as an IP address associated with a location which is known to have previously been conducive to peaceful behavior may be interpreted as complementary or additional data of substance, provided it has no meaningful overlap or lack of association with normative data previously gathered.

Next, the data obtained from the usage-based biometric data module 332 may be interpreted 340 to obtain one or more potential imprecise characteristics and a report is generated 342.

According to one example, an accelerometer may be utilized to collect biometric data 344. An accelerometer-based biometric data module 346 may generate biometric data from the motion of the application or device, such as a tablet or other computing device. For example, a motion module 348 within the accelerometer-based biometric data module 346 may analyze the movement and the rate of the movement of the device over time to determine accelerometer related data (i.e. potential imprecise characteristics) based on the shakes, jiggles, angle or other information that the physical device provides. An accelerometer module 336 within the usage-based biometric data module 332 may analyze the input behavior and/or concurrent movement to determine use related data based on the input behavior, speed, and even the strength of these user- and action-based signals.

According to one example, a peripheral may be utilized to collect biometric data 358. A peripheral data module 360 may generate peripheral data related to contextual data associated with the application or device, such as a tablet or other computing device. For example, a time and location module 364 may analyze the location, time and date of the device over time to determine if the device is in the same place as a previous time notation taken during a different session. A biotelemetrics module 362 within the peripheral data module 360 may analyze the heart rate, breathing, temperature, or other related factors to determine biotelemetrics (i.e. potential imprecise characteristics). A social network activities module 366 within the peripheral data module 360 may analyze social media activity, content viewed, and other network-based content to determine if media such as videos, music or other content, or related interactions with people, such as family and friends, or related interactions with commercial entities, such as recent purchases, may have affected the probable state of the user. A relational datasets module 368 within the peripheral data module 360 may analyze additional records or content that was intentionally or unintentionally submitted such as past health or financial records, bodies of text, images, sounds, and other data that may be categorized with the intent of building context around the probable state of the user. That is, a profile of each user may be generated and stored in the device or on a server which can be accessed and utilized when determining the potential imprecise characteristics and precise characteristics of the user.

Next, the data obtained from peripheral data module 360 (i.e. potential imprecise characteristics) may be interpreted 370 and a report is generated 372.

In the same manner as the semantic data was compared to a pre-existing dataset to determine the value of the data relative to the sentiment, mood, or affect that it indicates, the measurements of biometric data may take the same path. The final comparisons of the data values 372 specifically where redundant values coincide 374 provides the emotional state of the conversant.

The measurements of biometric data may also be assigned weighted descriptive values and a weighted time value as is described above in FIG. 2 with regard to assessing the semantic mood of an individual. Specifically, the probability of the biometric data accurately reflecting the individual may be approximated using the following formula:

P(i)=w₀*t₀(t)*c₀+ . . . wᵢ*tᵢ(t)*cᵢ+wₚ*P(i−1)

Furthermore, the estimated strength of the biometric data may be approximated using the following formula:

S(i)=w₀*t₀(t)*s₀+wᵢ*tᵢ(t)*sᵢ+wₛ*S(i−1)

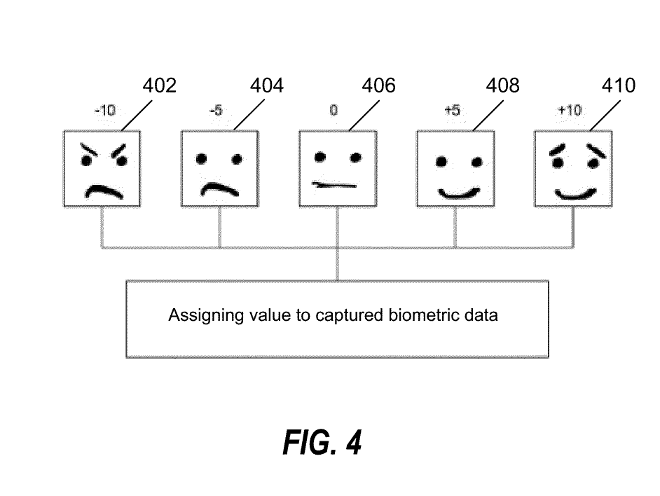

FIG. 4 illustrates a biometric mood scale for determining an emotional value in the form of one or more potential imprecise characteristics that is associated with sentiment of an emotion, affect or other representations of moods of an individual based on facial expressions, according to an aspect of the present disclosure. As shown, a numerical value, such as a weighted descriptive value as described above, may be assigned to static facial expressions. In the example shown, the facial expressions may include “hate” 402, “dislike” 404, “neutral” 406, “like” 408 and “love” 410, where “hate” has a numerical value of −10, “dislike” has a numerical value of −5, “neutral” has a numerical value of 0, “like” has a numerical value of +5 and “love” has a numerical value of +10. The facial expressions may be determined by using a camera to collect biometric data of an individual, as described above.

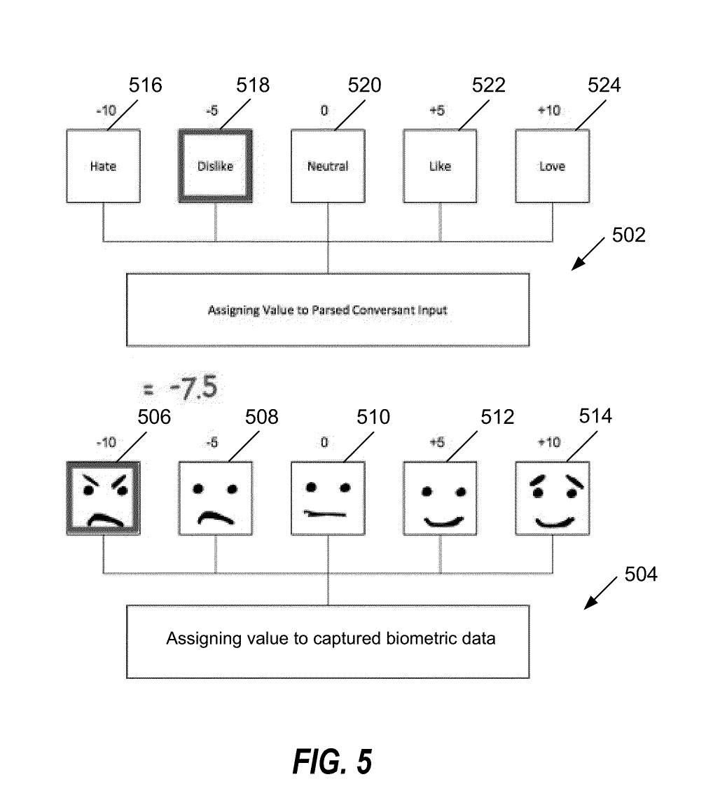

FIG. 5 illustrates mood scales for determining an emotional value in the form of one or more potential imprecise characteristics that is associated with sentiment of an emotion, affect or other representations of moods of an individual based on facial expressions and parsed conversant input, according to an aspect of the present disclosure. As shown, an average value of a semantic mood scale 502 and a biometric mood scale 504 may be used to determine a single mood value.

As shown, the sematic mood scale 502 may assign a numerical value to lexical representations of the sentiment of the parsed conversant input. In the example shown, the lexical representations may include “hate” 506, “dislike” 508, “neutral” 510, “like” 512 and “love” 514, where “hate” has a numerical value of −10, “dislike” has a numerical value of −5, “neutral” has a numerical value of 0, “like” has a numerical value of +5 and “love” has a numerical value of +10. The lexical representations may be determined as described above.

As shown, the biometric mood scale 504 may assign a numerical value, such as a weighted descriptive value as described above, to facial expressions. In the example shown, the facial expressions may include “hate” 516, “dislike” 518, “neutral” 520, “like” 522 and “love” 524, where “hate” has a numerical value of −10, “dislike” has a numerical value of −5, “neutral” has a numerical value of 0, “like” has a numerical value of +5 and “love” has a numerical value of +10. The facial expressions may be determined by using a camera to collect biometric data of an individual, as described above.

In the example shown, the numerical value, such as a weighted descriptive value as described above, assigned to the facial expression is −10 while the numerical value assigned to the lexical representation of the sentiment of the parsed conversant input is −5. To determine a single numerical value representing the mood of the individual, the values of all the numerical values are added together and then divided by the total number of values that have been added together. In the example shown, the single numerical value is −7.5 (−10+−5=−15; −15/2=−7.5).

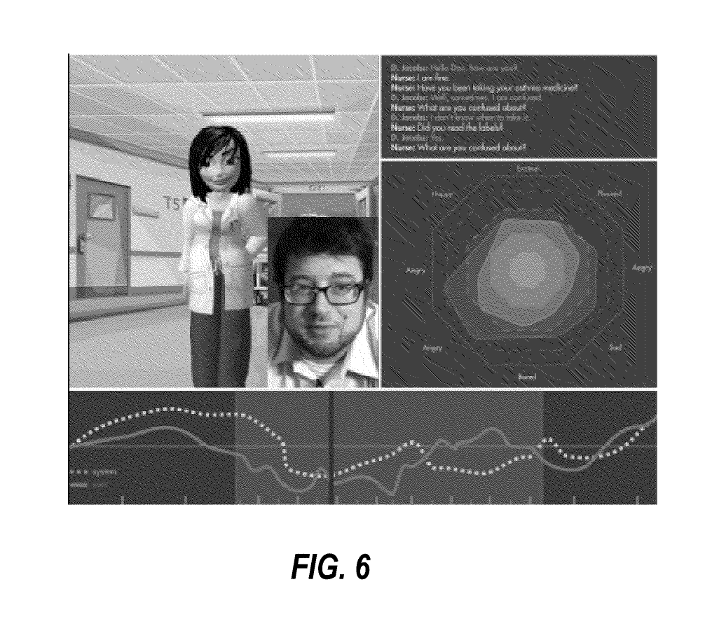

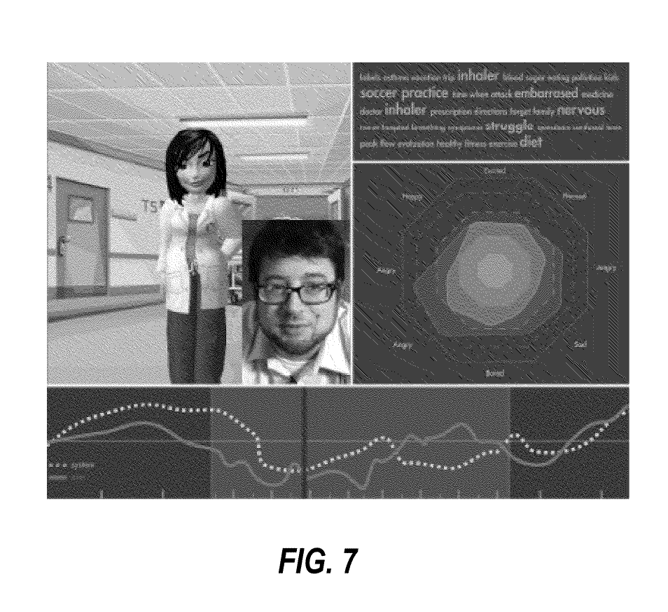

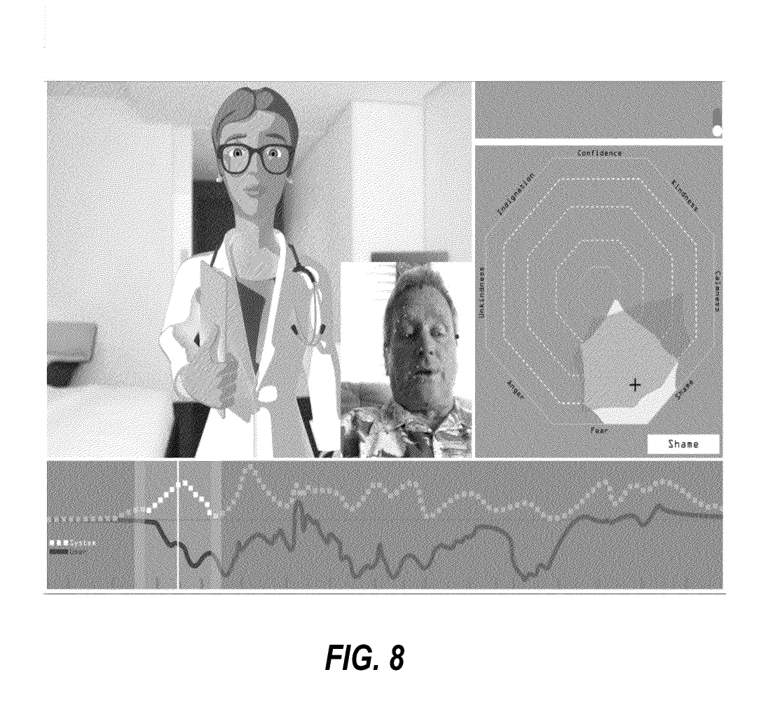

FIGS. 6, 7 and 8 illustrate examples of determining the biometric mood of an individual, according to an aspect of the present disclosure. As shown, as the individual appears in front of a camera which is used to determine various data used to determine the biometric mood. For example, as described above, the camera may capture images and/or video to determine head related data and body related data based on the position of the head and the body of the individual in front of the camera.

As shown, specific points or locations on the face of an individual may be monitored and movement of these locations may be plotted on a graph in real time. In one example, an octagonal shaped graph may be used to monitor an individual's mood in real time. Each side of the octagonal shaped graph may represent an emotion, such as angry, sad, bored, happy, excited, etc. While the individual is located in front of the camera, the position and motion of the body and head of the individual is mapped or tracked in real time on the graph as shown in FIGS. 6, 7 and 8. When an input is collected, such as a single input for a single facial expression or a single tone of voice that represents a single sentiment value or potential imprecise characteristic, this is plotted on the graph next to other inputs that represent that same vector (such as facial expression or tone of voice). As these are collected over a delta of time, usually less than a second, this cluster of data, when outlined, draws a shape. As soon as the delta of time changes or the input data collected from the conversant changes, such as the expression of the face or tone of voice, the shape and position of the data visualization changes its coordinates on the graph.

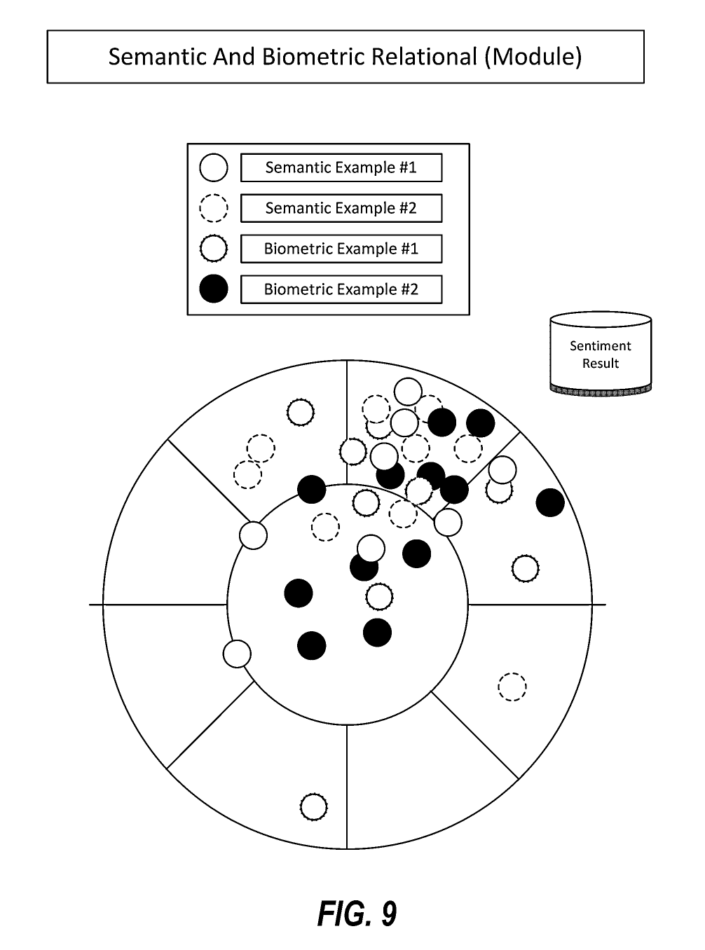

FIG. 9 illustrates a graphical representation of a report on the analysis of semantic data and biometric data (or potential imprecise characteristics) collected, according to an aspect of the disclosure. Each section of the circular chart may correlate to a sentiment. Examples of sentiments include, but are not limited to, confidence, kindness, calmness, shame, fear, anger, unkindness and indignation. As shown in the chart of FIG. 9, collected semantic data and biometric data (or potential imprecise characteristics) are placed on the chart in a location that most reflects the data. If a data point is determined to contain fear, then that data point would be placed in the fear section of the chart. The overall sentiment of the individual may be determined by section of the chart with the most data points.

### Devices

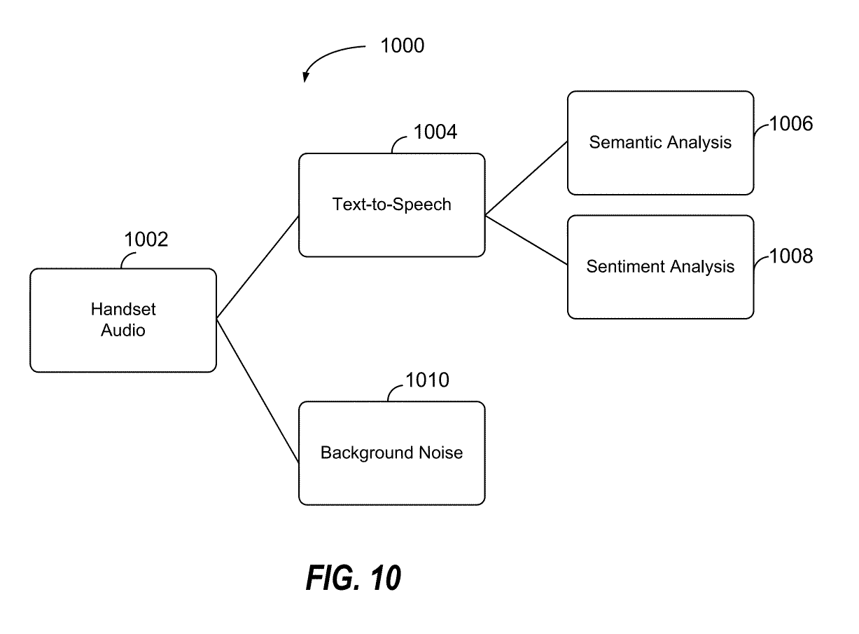

FIG. 10 illustrates a flow chart illustrating a method of a handset collecting and evaluating media streams, such as audio 1000, according to an aspect of the present disclosure. First, a mobile device or handset 1002 may receive a media stream in the form of audio. One or more modules located within the mobile device 1002, as described in more detail below, may receive an audio media stream. Alternatively, the modules for analyzing the data may be located on a server, separate from the handset where the data is transmitted wireless (or wired) to the server. For example, although some media streams may be classified for use by the one or more modules on the handset 1002 and sent directly to a server, in communication with the handset via a network, without further processing, coding or analysis; most processing, coding and/or analysis of the media streams may occur on the handset or mobile device 1002. For example, audio received by the handset or mobile device 1002 may be sent to one or more text-to-speech engines 1004 which may then send the audio to a semantic analysis (or module) 1006 and/or a sentiment analysis engine (or module) 1008. The audio may also be simultaneously analyzed for speech stress patterns, and also by an algorithm to look at background noise 1010.

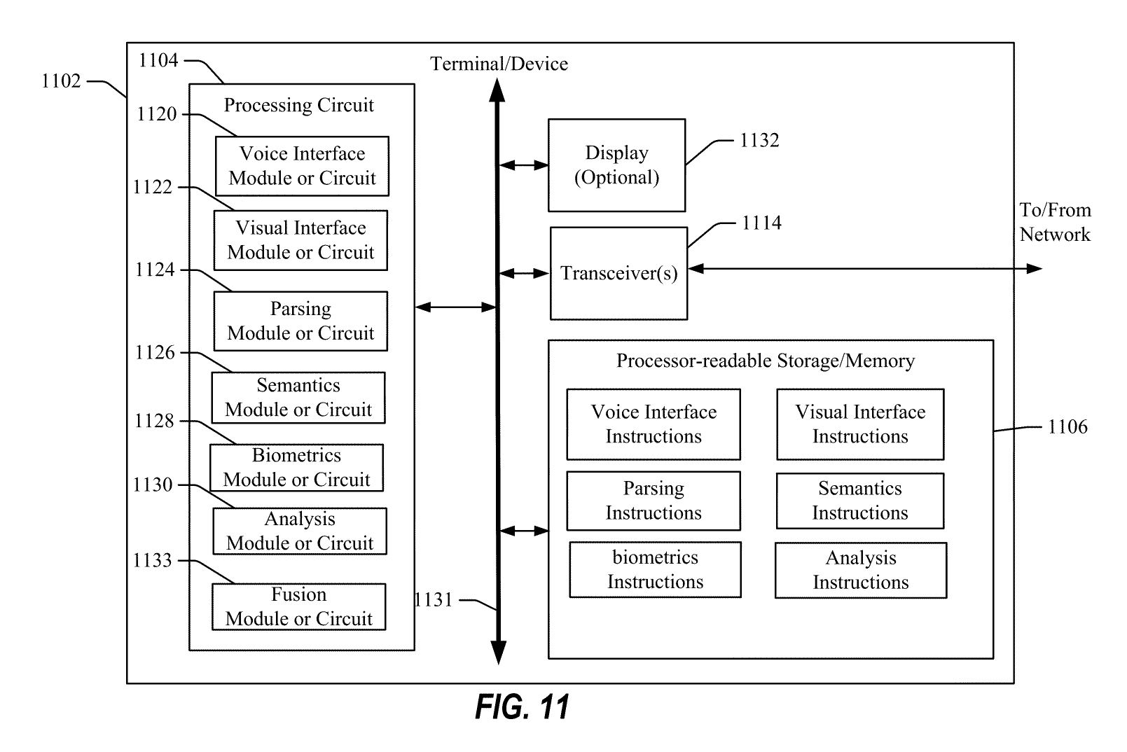

FIG. 11 is a diagram 1100 illustrating an example of a hardware implementation for a system 1102 configured to measure semantic and biometric affect, emotion, intention and sentiment (i.e. potential imprecise and precise characteristics) via relational input vectors or other means using national language processing, according to an aspect of the present disclosure. The system 1102 may be a handset and/or other computing devices such as a server. As described previously, the handset may be wirelessly (or wired) connected to the server. The system 1102 may include a processing circuit 1104. The processing circuit 1104 may be implemented with a bus architecture, represented generally by the bus 1131. The bus 1131 may include any number of interconnecting buses and bridges depending on the application and attributes of the processing circuit 1104 and overall design constraints. The bus 1131 may link together various circuits including one or more processors and/or hardware modules, processing circuit 1004, and the processor-readable medium 1106. The bus 1131 may also link various other circuits such as timing sources, peripherals, and power management circuits, which are well known in the art, and therefore, will not be described any further.

The processing circuit 1104 may be coupled to one or more communications interfaces or transceivers 1114 which may be used for communications (receiving and transmitting data) with entities of a network.

The processing circuit 1104 may include one or more processors responsible for general processing, including the execution of software stored on the processor-readable medium 1006. For example, the processing circuit 1104 may include one or more processors deployed in the mobile computing device (or handset) 102 of FIG. 1. The software, when executed by the one or more processors, cause the processing circuit 1104 to perform the various functions described supra for any particular terminal. The processor-readable medium 1106 may also be used for storing data that is manipulated by the processing circuit 1104 when executing software. The processing system further includes at least one of the modules 1120, 1122, 1124, 1126, 1128, 1130 and 1133. The modules 1120, 1122, 1124, 1126, 1128, 1130 and 1133 may be software modules running on the processing circuit 1104, resident/stored in the processor-readable medium 1106, one or more hardware modules coupled to the processing circuit 1104, or some combination thereof.

In one configuration, the mobile computer device 1102 for wireless communication includes a module or circuit 1120 configured to obtain verbal communications from an individual verbally interacting (e.g. providing human or natural language input or conversant input) to the mobile computing device 1102 and transcribing the natural language input into text, module or circuit 1122 configured to obtain visual (somatic or biometric) communications from an individual interacting (e.g. appearing in front of) a camera of the mobile computing device 1102, and a module or circuit 1124 configured to parse the text to derive meaning from the natural language input from the authenticated consumer. The processing system may also include a module or circuit 1126 configured to obtain semantic information of the individual to the mobile computing device 1102, a module or circuit 1128 configured to obtain somatic or biometric information of the individual to the mobile computing device 1102, a module or circuit 1130 configured to analyze the semantic as well as somatic or biometric information of the individual to the mobile computing device 1102, and a module or circuit 1133 configured to fuse or combine potential imprecise characteristics to create or form one or more precise characteristics.

In one configuration, the mobile communication device (or handset) 1102 may optionally include a display or touch screen 1132 for receiving and displaying data to the consumer (or individual).

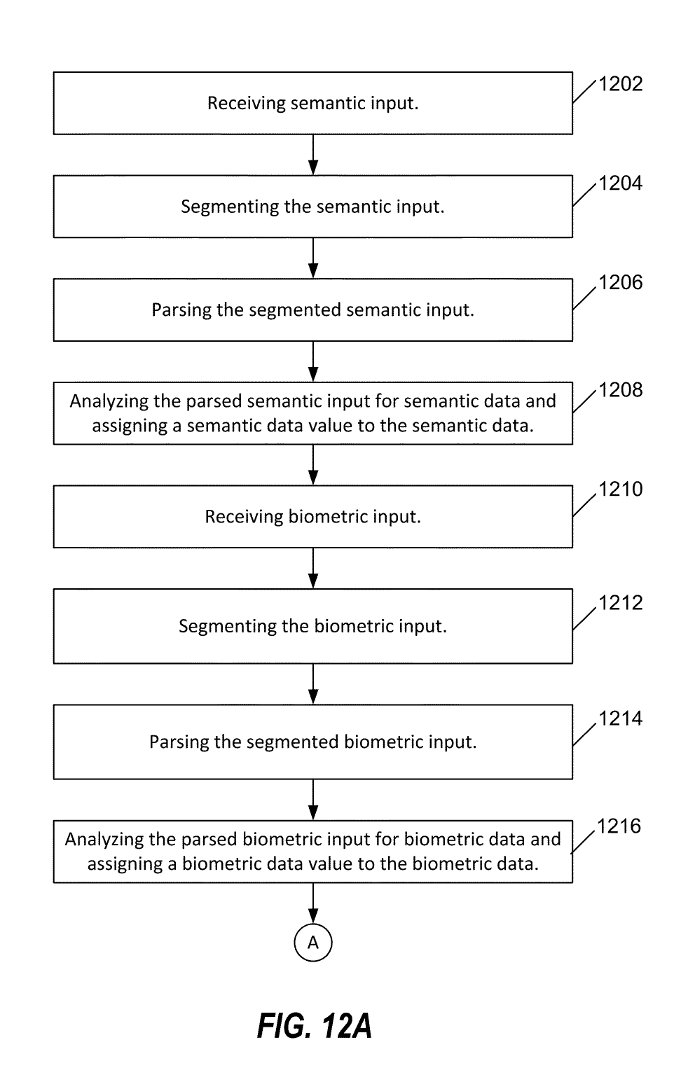

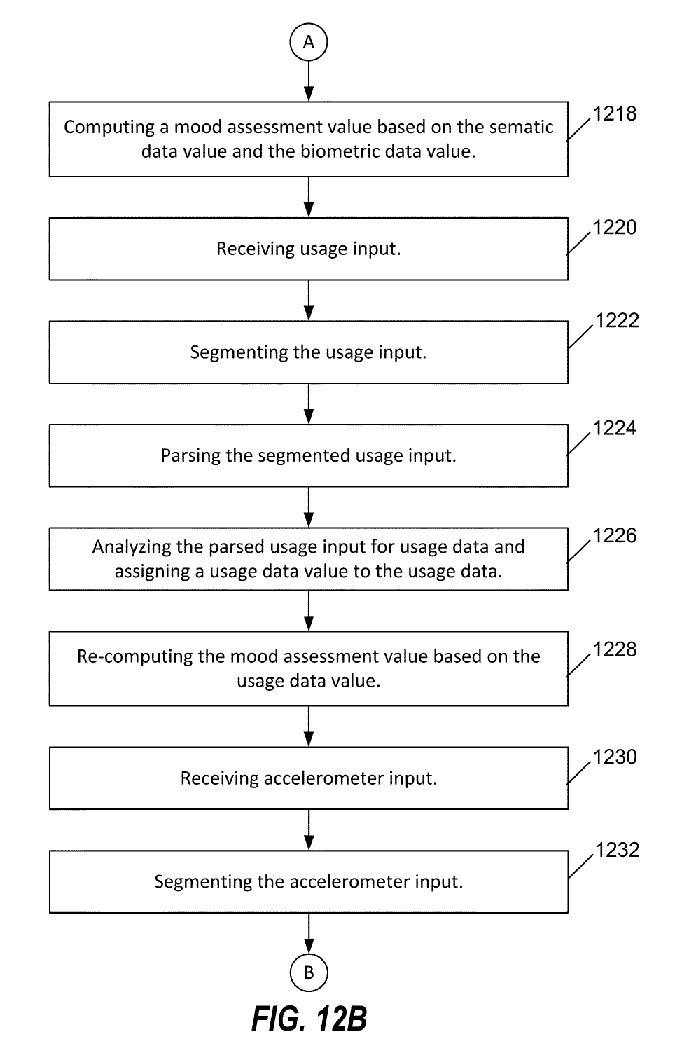

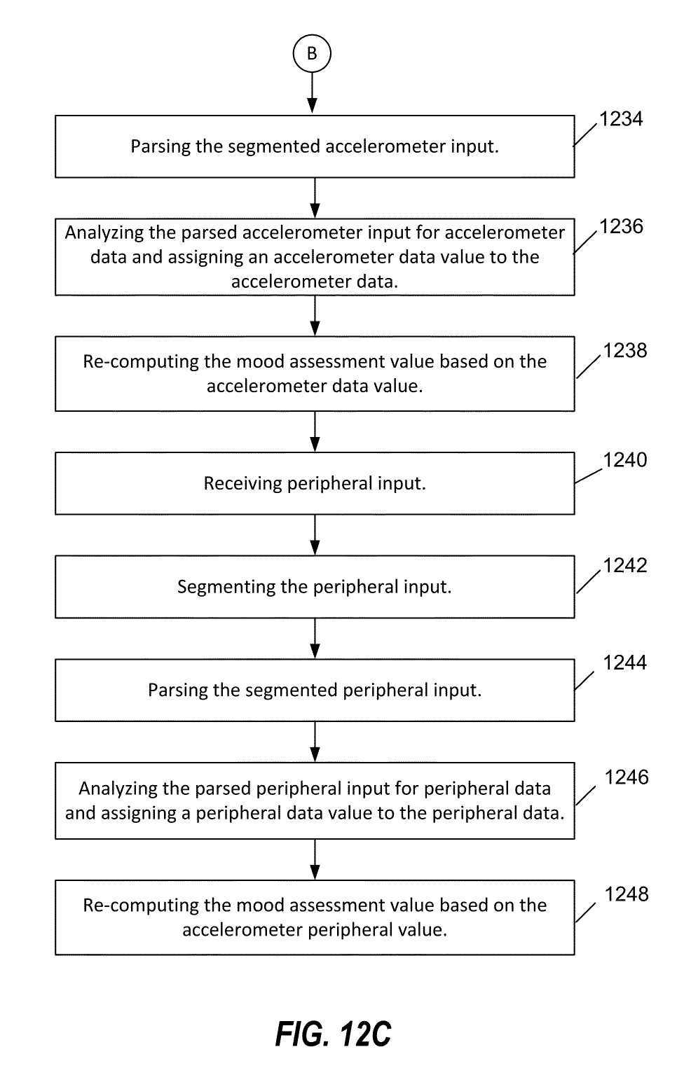

FIGS. 12A, 12B and 12C illustrate a method for measuring semantic and biometric affect, emotion, intention, mood and sentiment via relational input vectors using national language processing, according to one example. First, semantic input is received 1202. The semantic input may be textual input. The semantic input is segmented 1204 and parsed using a parsing module to identify the intent of the semantic input 1206. The segmented, parsed semantic input may then be analyzed for semantic data and a semantic data value for each semantic data point identified is assigned 1208.

Next, biometric input may be received 1210. The biometric input may include audio input, visual input and biotelemetry input (e.g. data is at least one of heart rate, breathing, temperature and/or blood pressure). The biometric input may be received from a microphone, a camera, an accelerometer and/or a peripheral device.

The biometric input may be segmented 1212 and parsed using the parsing module 1214. The segmented, parsed biometric input may then be analyzed for biometric data (i.e. potential imprecise characteristics) and a biometric data value (i.e. weighted descriptive value) for each biometric data point identified is assigned 1216. A mood assessment value (i.e. weighted descriptive value) may then be computed based on the semantic data value(s) and the biometric data value(s) 1218. The mood assessment value (i.e. weighted descriptive value) may be a lexical representation of the sentiment of the user.

Optionally, usage input may be received 1220. The usage input may be obtained from use of an application of a mobile device, for example the use of a touch-screen on the surface of the device. The usage input may be segmented 1222 and parsed using the parsing module 1224. The segmented, parsed usage input may then be analyzed for usage data (i.e. potential imprecise characteristics) and a usage data value (i.e. weighted descriptive value) for each usage data point identified may be assigned 1226. The mood assessment value may then be re-computed based on the usage data value(s) 1228.

Optionally, accelerometer input may be received 1230. The accelerometer input may be segmented 1232 and parsed using the parsing module 1234. The segmented, parsed accelerometer input (i.e. potential imprecise characteristics) may then be analyzed for accelerometer data and an accelerometer data value (i.e. weighted descriptive value) for each accelerometer data point identified may be assigned 1236. The mood assessment value may then be re-computed based on the accelerometer data value(s) 1238.

Optionally, peripheral input may be received 1240. The peripheral input may be obtained from a microphone, a camera and/or an accelerometer, for example. The peripheral input may be segmented 1242 and parsed using the parsing module 1244. The segmented, parsed peripheral input may then be analyzed for peripheral data (i.e. potential imprecise characteristics) and a peripheral data value (i.e. weighted descriptive value) for each peripheral data point identified may be assigned 1246. The mood assessment value may then be re-computed based on the peripheral data value(s) 1248.

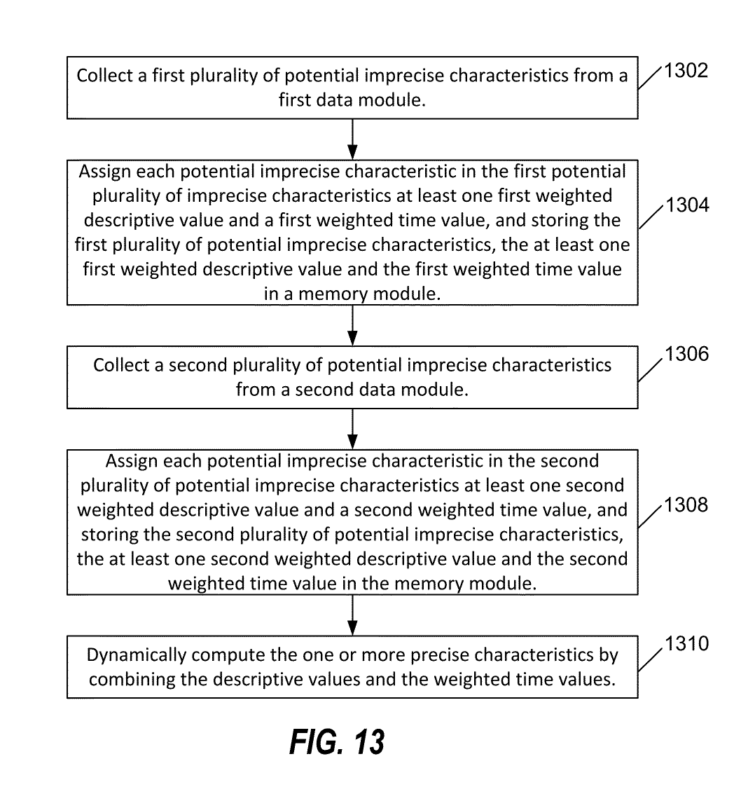

FIG. 13 illustrates a method of dynamically collecting and evaluating one or more sets of potential imprecise characteristics for creating one or more precise characteristics, according to an aspect of the present disclosure. First, a first plurality of potential imprecise characteristics may be collected from a first data module 1302. Next, each potential imprecise characteristic in the first plurality of potential imprecise characteristics may be assigned at least one first weighted descriptive value and a first weighted time value. The plurality of potential imprecise characteristics, as well as the assigned weighted descriptive values and the assigned weighted time value, may be stored in a memory module located on a handset, a server or other computing device 1304.

A second plurality of potential imprecise characteristics from a second data module may be collected 1306. The first and second data modules may be the same or different. Additionally, the data modules may be located on the handset or may be located on a peripheral device. Next, each potential imprecise characteristic in the second plurality of potential imprecise characteristics may be assigned at least one second weighted descriptive value and a first weighted time value. The plurality of potential imprecise characteristics, as well as the assigned weighted descriptive values and the assigned weighted time value, may be stored in a memory module located on the handset or the server 1308. This process may be repeated to collect as many potentially imprecise characteristics as is needed to determine the one or more precise characteristics.

Finally, the one or more precise characteristics are dynamically computed by combining or fusing the descriptive values and the weighted time values 1310.

### Semantic and Biometric Elements

Semantic and biometric elements may be extracted from a conversation between a software program and a user and these elements may be analyzed as a relational group of vectors to generate reports of emotional content, affect, and other qualities. These dialogue elements are derived from two sources.

First is semantic, which may be gathered from an analysis of natural language dialogue elements via natural language processing methods. This input method measures the words, topics, concepts, phrases, sentences, affect, sentiment, and other semantic qualities. Second is biometric, which may be gathered from an analysis of body language expressions via various means including cameras, accelerometers, touch-sensitive screens, microphones, and other peripheral sensors. This input method measures the gestures, postures, facial expressions, tones of voice, and other biometric qualities. Reports may then be generated that compare these data vectors such that correlations and redundant data give increased probability to a final summary report. For example, the semantic reports from the current state of the conversation may indicate the user as being happy because the phrase “I am happy” is used, while biometric reports may indicate the user as being happy because their face has a smile, their voice pitch is up, their gestures are minimal, and their posture is relaxed. When the semantic and biometric reports are compared there is an increased probability of precision in the final summary report. Compared to only semantic analysis, or only biometric analysis, which generally show low precision in measurements, enabling a program to dynamically generate these effects increases the apparent emotional intelligence, sensitivity, and communicative abilities in computer-controlled dialogue.

One or more of the components, steps, and/or functions illustrated in the figures may be rearranged and/or combined into a single component, step, or function or embodied in several components, steps, or functions without affecting the operation of the communication device having channel-specific signal insertion. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

While certain exemplary embodiments have been described and shown in the accompanying drawings, it is to be understood that such embodiments are merely illustrative of and not restrictive on the broad application, and that this application is not be limited to the specific constructions and arrangements shown and described, since various other modifications may occur to those ordinarily skilled in the art.

1. A computer implemented method of dynamically collecting and evaluating one or more sets of potential imprecise characteristics for creating one or more precise characteristics, comprising executing on a processor the steps of:
collecting a first plurality of potential imprecise characteristics from a first data module in communication with the processor;
assigning each potential imprecise characteristic in the first plurality of potential imprecise characteristics at least one first weighted descriptive value and a first weighted time value, and storing the first plurality of potential imprecise characteristics, the at least one first weighted descriptive value and the first weighted time value in a memory module;
collecting a second plurality of potential imprecise characteristics from a second data module in communication with the processor;
assigning each potential imprecise characteristic in the first plurality of potential imprecise characteristics at least one second weighted descriptive value and a second weighted time value, and storing the second plurality of potential imprecise characteristics, the at least one second weighted descriptive value and the second weighted time value in the memory module; and
dynamically computing the one or more precise characteristics by combining the descriptive values and the weighted time values.

2. The method of claim 1, further comprising executing on the processor the steps of:
collecting a third plurality of potential imprecise characteristics from a third data module in communication with the processor; and
assigning each of the third plurality of potential imprecise characteristics in the third plurality of potential imprecise characteristics at least one third weighted descriptive value and a third weighted time value, and storing the third plurality of potential imprecise characteristics, the at least one third weighted descriptive value and the third weighted time value in the memory module.

3. The method of claim 1, wherein the first data module is a camera-based biometric data module.

4. The method of claim 3, wherein the camera-based biometric data module includes a position module for analyzing images and/or video captured from the camera-based biometric data module to determine the each potential imprecise characteristic in the first plurality of potential imprecise characteristics, and wherein the each imprecise characteristic in the first plurality of potential imprecise characteristics includes at least one of head related data and body related data based head and body positions of an individual in the images and/or video.

5. The method of claim 1, wherein the second data module is a peripheral data module.

6. The method of claim 5, wherein the peripheral data module includes a biotelemetrics module for analyzing data from the peripheral data module to determine the each potential imprecise characteristic in the second plurality of potential imprecise characteristics, and wherein the each potential imprecise characteristic the second plurality of potential imprecise characteristics includes at least one of heart rate, breathing rate and body temperature of an individual.

7. The method of claim 1, wherein the at least one first weighted descriptive value is assigned by comparing the each potential imprecise characteristic in the first plurality of potential imprecise characteristics to pre-determined characteristics located in a characteristic database; and wherein the at least one second weighted descriptive value is assigned by comparing the each potential imprecise characteristic in the second plurality of potential imprecise characteristics to the pre-determined characteristics located in a characteristic database.

8. The method of claim 7, wherein the characteristic database is dynamically built from the collected first and second plurality of potential imprecise characteristics.

9. The method of claim 1, wherein the at least one first weighted time value identifies a time in which the each potential imprecise characteristic in the first plurality of potential imprecise characteristics is collected; and wherein the at least one second weighted time value identifies a time in which the each potential imprecise characteristic in the second plurality of potential imprecise characteristics is collected.

10. The method of claim 1, further comprising executing on the processor the step of ranking the at least one first weighted descriptive value, the at least one second weighted descriptive value, the first time weighted value and the second time weighted value.

11. The method of claim 1, wherein the first and second plurality of potential imprecise characteristics are collected on a handset and transmitted to a server for analysis.

12. The method of claim 11, wherein the at least one first weighted descriptive value and the at least one second weighted descriptive value is assigned on the handset prior to transmission to the server.

13. The method of claim 11, wherein the at least one first weighted descriptive value and the at least one second weighted descriptive value is assigned on the server.

14. A mobile device for dynamically collecting and evaluating one or more sets of potential imprecise characteristics for creating one or more precise characteristics, the mobile device comprising:
a processing circuit;
a communications interface communicatively coupled to the processing circuit for transmitting and receiving information; and
a memory module communicatively coupled to the processing circuit for storing information, wherein the processing circuit is configured to:
collect a first plurality of potential imprecise characteristics from a first data module in communication with the processor;
assign each potential imprecise characteristic in the first plurality of potential imprecise characteristics at least one first weighted descriptive value and a first weighted time value in a analysis module within the processing circuit, and storing the first plurality of potential imprecise characteristics, the at least one first weighted descriptive value and the first weighted time value in the memory module;
collect a second plurality of potential imprecise characteristics from a second data module in communication with the processor;
assign each potential imprecise characteristic in the first plurality of potential imprecise characteristics at least one second weighted descriptive value and a second weighted time value in the analysis module within the processing circuit, and storing the second plurality of potential imprecise characteristics, the at least one second weighted descriptive value and the second weighted time value in the memory module; and
dynamically computing the one or more precise characteristics by combining the descriptive values and the weighted time values in a fusion module within the processing circuit.

15. The mobile device of claim 14, wherein the processing circuit is configured to:
collect a third plurality of potential imprecise characteristics from a third data module in communication with the processor; and
assign each of the third plurality of potential imprecise characteristics in the third plurality of potential imprecise characteristics at least one third weighted descriptive value and a third weighted time value, and storing the third plurality of potential imprecise characteristics, the at least one third weighted descriptive value and the third weighted time value in the memory module.

16. The mobile device of claim 14, wherein the at least one first weighted time value identifies a time in which the each potential imprecise characteristic in the first plurality of potential imprecise characteristics is collected; and wherein the at least one second weighted time value identifies a time in which the each potential imprecise characteristic in the second plurality of potential imprecise characteristics is collected.

17. The mobile device of claim 14, wherein the at least one first weighted descriptive value is assigned by comparing the each potential imprecise characteristic in the first plurality of potential imprecise characteristics to pre-determined characteristics located in a characteristic database; and wherein the at least one second weighted descriptive value is assigned by comparing the each potential imprecise characteristic in the second plurality of potential imprecise characteristics to the pre-determined characteristics located in a characteristic database.

18. The mobile device of claim 17, wherein the characteristic database is dynamically built from the collected first and second plurality of potential imprecise characteristics.

19. The mobile device of claim 18, wherein the first data module is different than the second data module.

20. The mobile device of claim 19, wherein the first data module is a camera and the second data module is an accelerometer.
